(19) United States
(12) Patent Application Publication
(10) Pub. No.: US 2006/0108388 A1
(43) Pub. Date: May 25, 2006

(54) Firing apparatus of a nailing gun

(76) Inventor: Chung-Ho Liu, Wufeng Shiang (TW)

Correspondence Address: Chung-Ho, Liu;c/o Yue Kin, Chu, 4972 Heritage Dr., Chino Hills, CA, 91709, US

(21) Appl. No.: 10/993,868

(22) Filed: Nov. 22, 2004

(51) Int. Cl. B25C 1/14

(52) U.S. Cl. 227/10

(57) ABSTRACT

A firing apparatus of a nailing gun with a gun body and a nail cartridge having a telescopic safety member mounted on a front part of a gun barrel and coupled with a push bar within a fixing sleeve disposed at the bottom of a gas chamber whereby the displacement of the push bar permits a contact with a compression tongue of a trigger unit to proceed with a discharge process. A three-stage longitudinal slot is correspondingly provided in a pair of side flanks of the trigger unit. The compression tongue is pivotally connected to the trigger unit through a pivot pin that is movable along the three-stage longitudinal slot whereby the movement of the pivot pin along the three-stage longitudinal slot of the trigger unit allows an adjustment of the position of the compression tongue relative to the push bar, thereby achieving three operating modes: continuous discharge, single discharge and out-of-action mode.

### BACKGROUND OF THE INVENTION

1. Fields of the Invention

The invention relates to a firing apparatus of a nailing gun, and more particularly, to a firing apparatus that employs a simple measure to allows a convenient shift of three operational modes: single discharge, continuous discharge and out-of-action mode.

2. Description of the Related Art

Generally, a conventional nailing gun is fitted with a safety member to prevent the gun from being fired accidentally. The safety member employs its front contact surface to contact with a workpiece for a firing process. Meanwhile, the safety member is coupled with a trigger unit of the nailing gun so that an expected safety effect is ensured. The embodiment, as shown in FIGS. 10 through 13, has been disclosed by the inventor of the present invention. As shown in FIGS. 10 through 13, the structure includes a gun body 11 and a nail cartridge 12. A safety member 14 is mounted on a gun barrel 13 of the gun body 11 and is coupled with a push bar 16 of a projecting block 15 disposed at the bottom of the gun body 11. In this way, the displacement of the push bar 16 permits a contact with a compression tongue 18 of a trigger unit 17 to proceed with a discharge process. The push bar 16 has a semicircular section 161. A U-shaped bracket 19 is mounted on a projecting block 15 and provided with a semicircular hole 191 in each of both side flanks for insertion of the push bar 16. By changing the assembly angle of the U-shaped bracket 19, as shown in FIGS. 10 and 12, the contact surface of the push bar 16 with the compression tongue 18 is adjustable (see FIGS. 11 and 13). In this way, the operation of the nailing gun can be changed from single discharge mode shown in the FIGS. 10 and 11 to the continuous discharge mode shown in the FIGS. 12 and 13.

However, the above-mentioned configuration still has drawbacks. In changing the operational modes, the safety member 14 and the push bar 16 have to be dismantled to allow a take out action of the U-shaped bracket 19. After adjustment to a desired mode, the U-shaped bracket 19 has to be assembled with the opposite process to a proper position. It takes much time and efforts and brings troubles to the operators.

### SUMMARY OF THE INVENTION

It is a primary object of the invention is to provide a firing apparatus of a nailing gun that a three-stage longitudinal slot is correspondingly formed in a pair of side flanks of the trigger unit. A compression tongue is pivotally connected to the trigger unit through a pivot pin that is movable along the three-stage longitudinal slot whereby the movement of the pivot pin along the three-stage longitudinal slot of the trigger unit allows an adjustment of the position of the compression tongue relative to the push bar, thereby achieving three operating modes of continuous discharge, single discharge and out of action.

### BRIEF DESCRIPTION OF THE DRAWINGS

The accomplishment of this and other objects of the invention will become apparent from the following description and its accompanying drawings of which:

FIG. 1 is a partial exploded view of the invention in section;

FIG. 2 is a sectional view of the invention in continuous discharge mode;

FIG. 3 is a sectional view of the invention in accordance with FIG. 2, showing the operation thereof;

FIG. 4 is a sectional view of the invention in accordance with FIG. 2, showing a continuous operation thereof;

FIG. 5 is a sectional view of the invention in a single discharge mode;

FIG. 6 is a sectional view of the invention in accordance with FIG. 5, showing the operation thereof;

FIG. 7 is a sectional view of the invention in accordance with FIG. 5, showing a continuous operation thereof;

FIG. 8 is a schematic drawing of the invention in accordance with FIG. 5, showing that the push bar and the compression tongue are out of action when first the trigger unit and then the telescopic member are compressed;

FIG. 9 is a sectional view of the invention in an out-of-action mode;

FIG. 10 is a partial exploded view of a prior art;

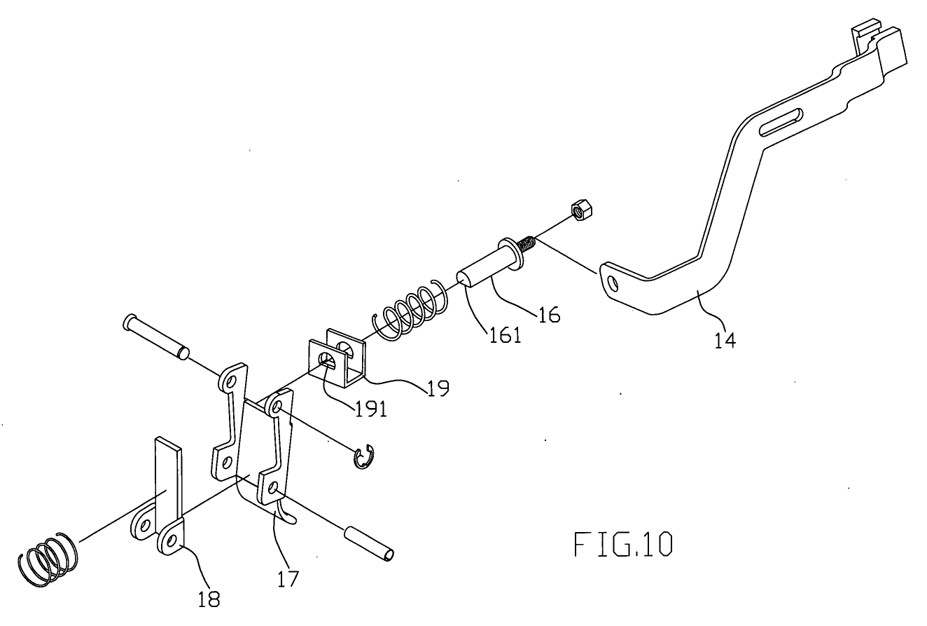

FIG. 11 is a sectional view of the prior art in accordance with FIG. 10;

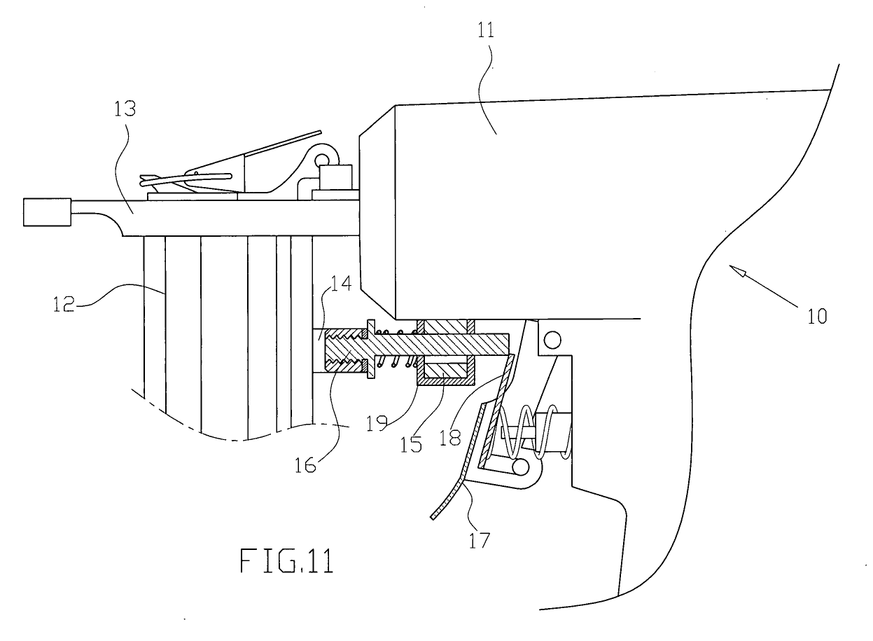

FIG. 12 is a partial exploded view of the prior art in adjusting the operational mode; and

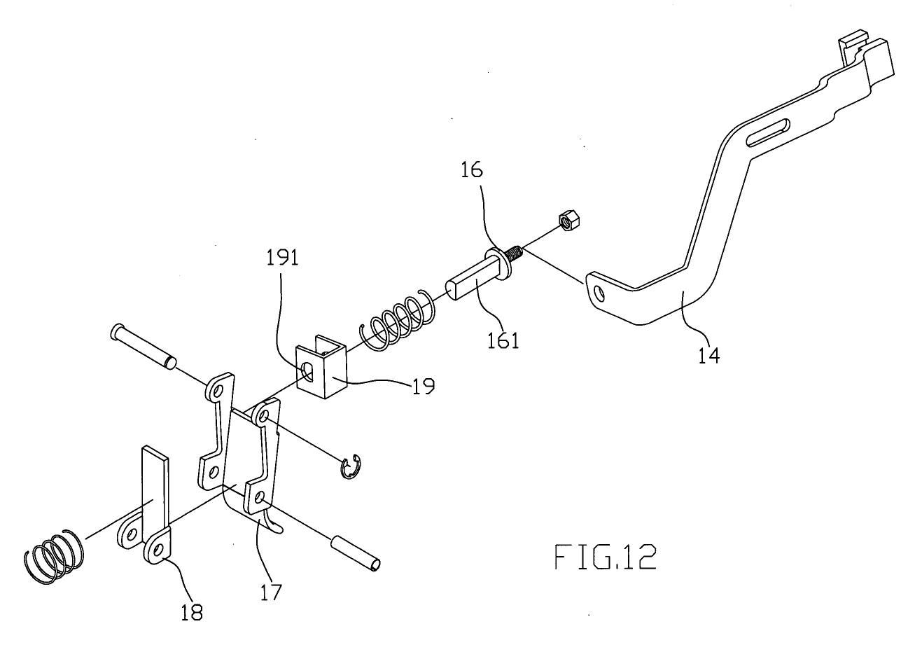

FIG. 13 is a sectional view of the prior art in accordance with FIG. 12.

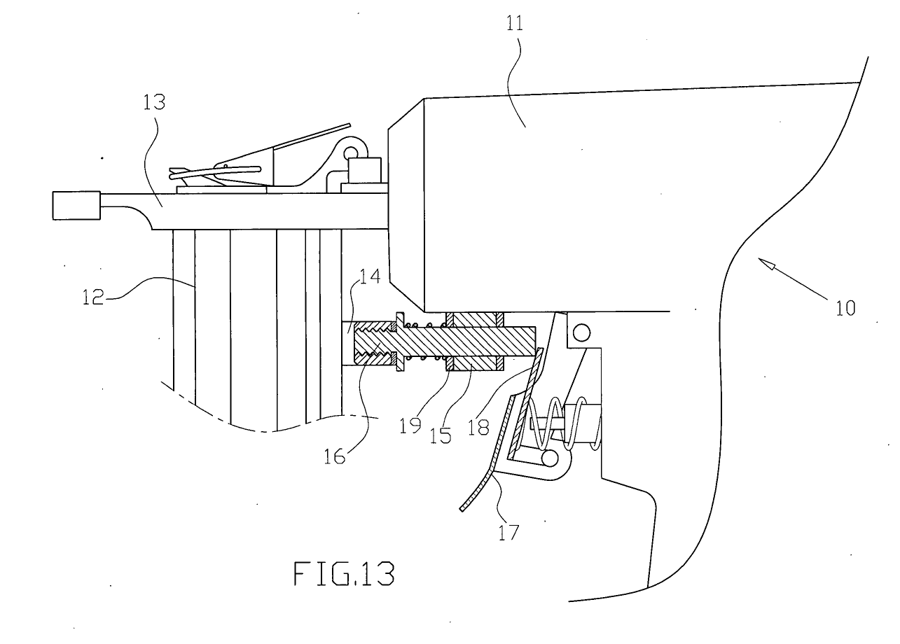

### DETAILED DESCRIPTION OF THE PREFERRED EMBODIMENT

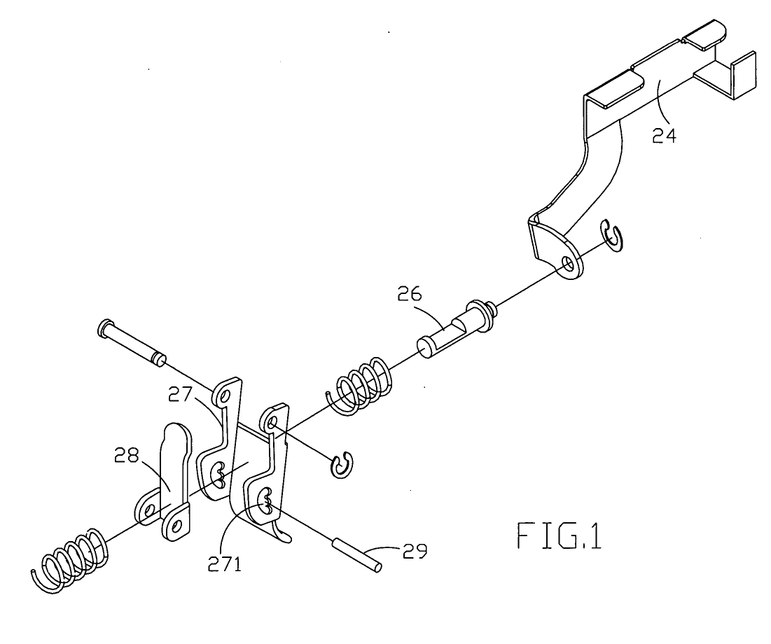

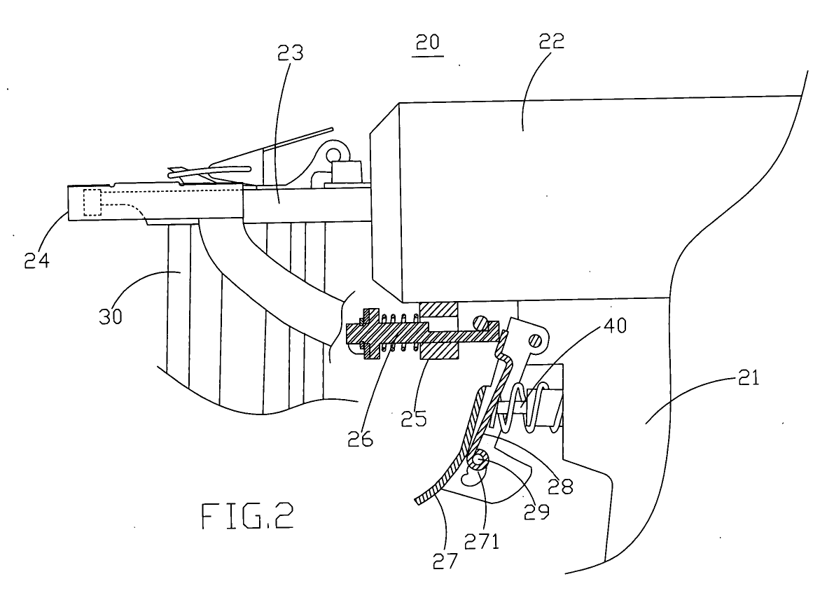

Referring to FIGS. 1 and 2, a firing apparatus of a nailing gun in accordance with the invention includes a gun body 20, a nail cartridge 30:

The gun body 20 includes a handle 21 and an air chamber 22. A gun barrel 23 is provided at a front end of the air chamber 22. A telescopic safety member 24 is mounted on a front part of the gun barrel 23 and coupled with a push bar 26 within a fixing sleeve 25 disposed at the bottom of the gas chamber 22. The displacement of the push bar 26 permits a contact with a compression tongue 28 of a trigger unit 27 to proceed with a discharge process.

The nail cartridge 30 is disposed at right angles to the gun barrel 23. A plurality of nails received within the nail cartridge 30 can pass through an open groove at the bottom of the gun barrel 23 and enter into the gun barrel 23 for a nailing process.

A three-stage longitudinal slot 271 is correspondingly provided in a pair of side flanks of the trigger unit 27. The compression tongue 28 is pivotally connected to the trigger unit 27 through a pivot pin 29 that is movable along the three-stage longitudinal slot 271. The movement of the pivot pin 29 along the three-stage longitudinal slot 271 of the trigger unit 27 allows an adjustment of the position of the compression tongue 28 relative to the push bar 26, thereby achieving the three operating modes: continuous discharge, single discharge and out-of-action mode.

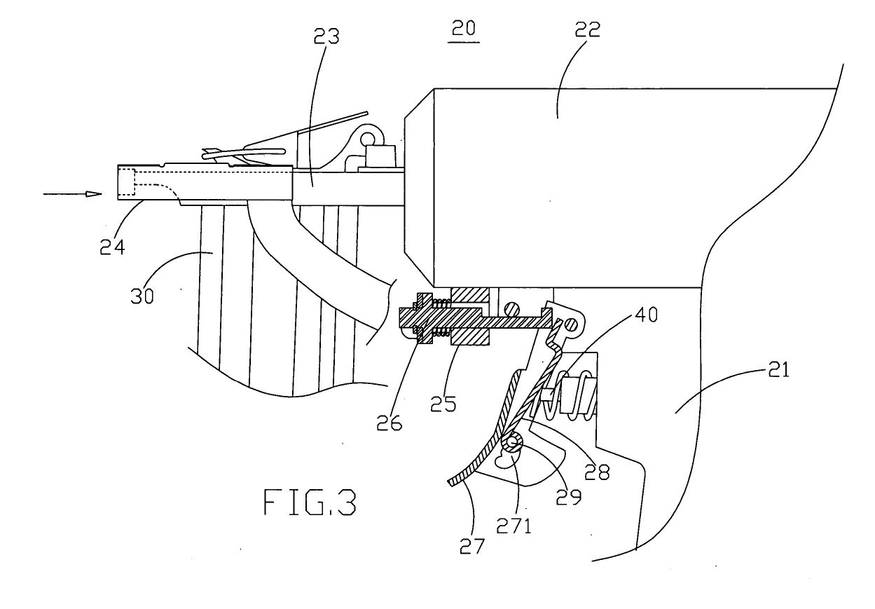

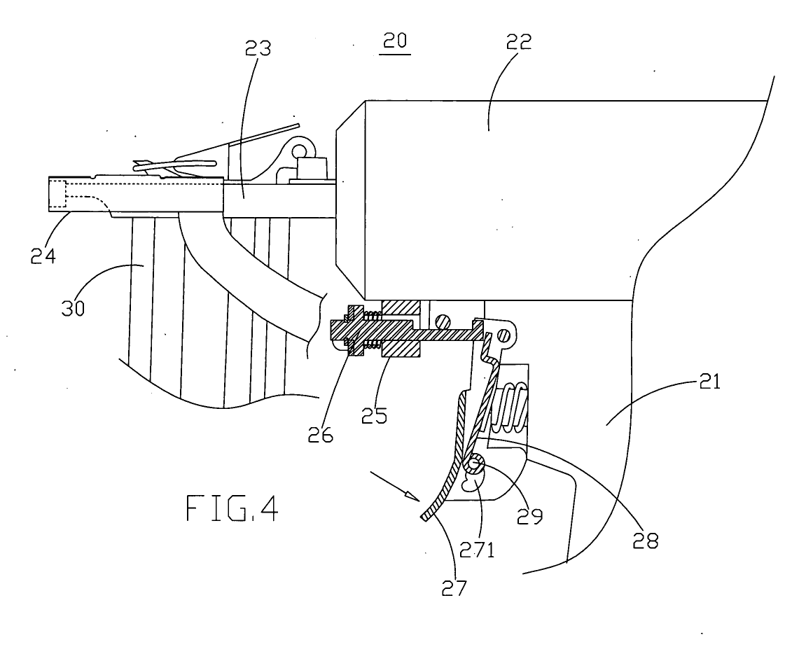

FIGS. 3 and 4 illustrate the continuous discharge mode of the invention. It's apparent from FIGS. 3 and 4 that the compression tongue 28 is sufficiently extended in contact with the push bar 26. After the single discharge process, the compression tongue 28 remains in contact with the push bar 26 even when the trigger unit 27 is not released or the telescopic safety member 24 is not returned to its original position. So, the discharge tappet 40 remains in compressed state to allow the performance of continuous discharge when the operator holds down the trigger unit 27 again or compresses the telescopic safety member 24 continuously.

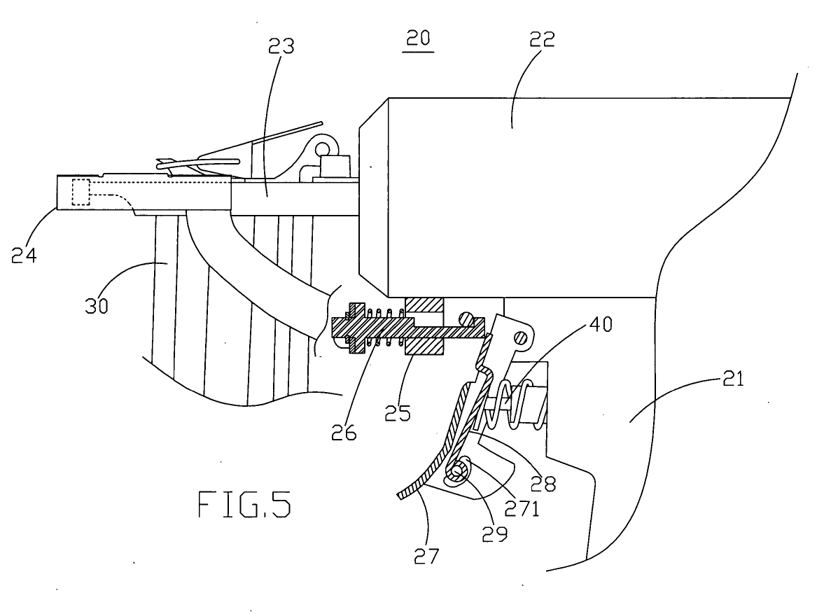

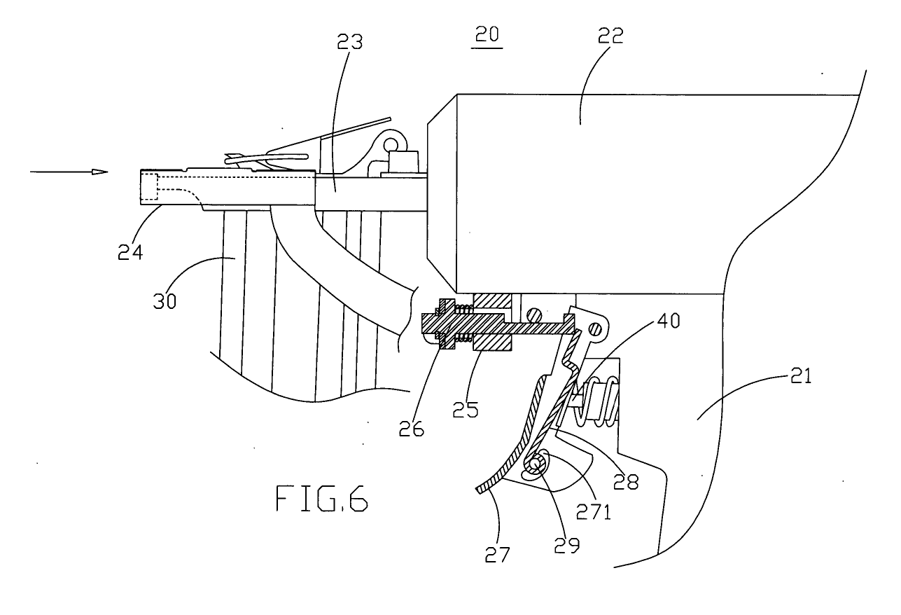

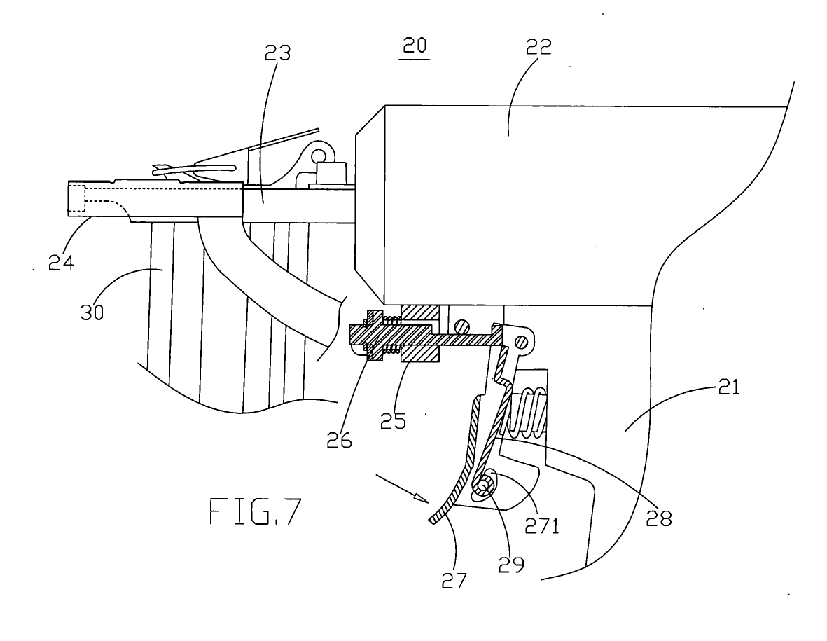

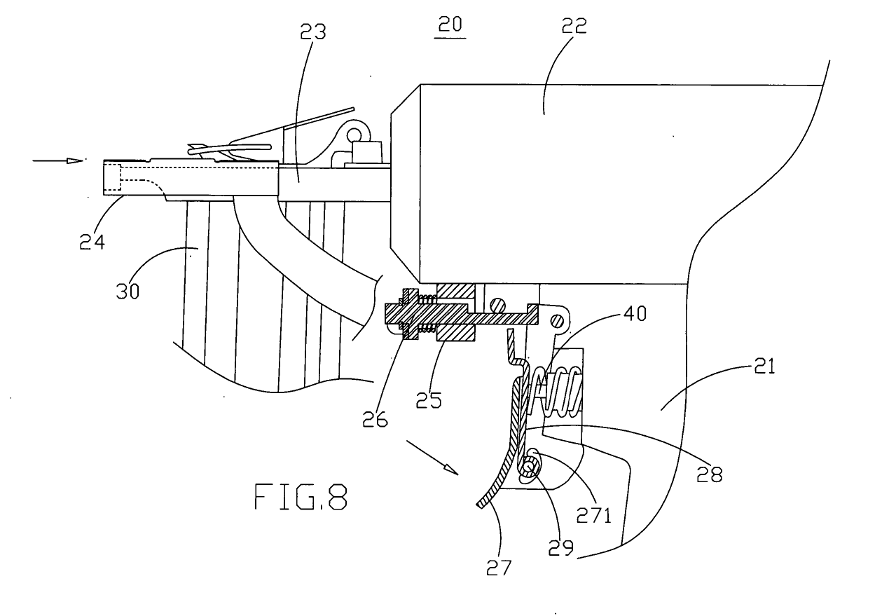

In order to shift the compression tongue 28 to the position of the single discharge mode, the pivot pin 29 has to be moved to middle section of the three-stage longitudinal slot 271 of the trigger unit 27, as shown in FIGS. 5 through 7. In this operational mode, only the free end of the compression tongue 28 is slightly extended in contact with the push bar 26. So, the compression tongue 28 will be detached from the push bar 26 after completion of the single discharge process (see FIG. 8). Meanwhile, the discharge tappet 40 is extended outwards. Unless the operator manually brings the push bar 26, the compression tongue 28, or the telescopic safety member 24 back to their original position, the push bar 26 doesn't contact with the compression tongue 28 to trigger the discharge tappet 40 for continuous nailing process.

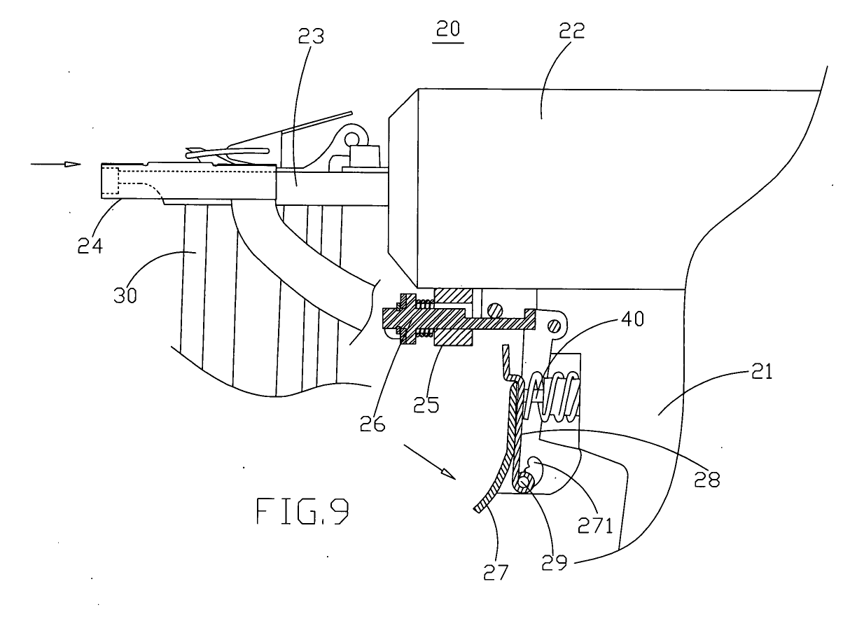

As shown in FIG. 9, the pivot pin 29 is moved downwardly to the lower position of the three-stage longitudinal slot 271 of the trigger unit 27. At this moment, it's impossible to bring the push bar 26 and the compression tongue 28 in contact with each other. Meanwhile, the trigger unit 27 doesn't have the triggering function to ensure the safety of the operator and people around him when the nailing gun is not used.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claim.

What is claimed is:

1. A firing apparatus of a nailing gun having a gun body and a nail cartridge, the firing apparatus comprising:
a) a telescopic safety member mounted on a front part of a gun barrel and coupled with a push bar within a fixing sleeve disposed at the bottom of a gas chamber whereby the displacement of the push bar permits a contact with a compression tongue of a trigger unit to proceed with a discharge process, and
b) a three-stage longitudinal slot correspondingly provided in a pair of side flanks of the trigger unit, the compression tongue being pivotally connected to the trigger unit through a pivot pin that is movable along the three-stage longitudinal slot whereby the movement of the pivot pin along the three-stage longitudinal slot of the trigger unit allows an adjustment of the position of the compression tongue relative to the push bar, thereby achieving three operating modes of continuous discharge, single discharge and out of action.
